(19) United States
(12) Patent Application Publication
(10) Pub. No.: US 2008/0184853 A1
(43) Pub. Date: Aug. 7, 2008

(54) Screw Positioning Sleeve Assembly

(76) Inventor: SHIOU-E CHEN, Kaohsiung County (TW)

Correspondence Address: Dr. BANGER SHIA, 102 Lindencrest Ct., Sugar Land, TX, 77479-5201, US

(21) Appl. No.: 11/671,939

(22) Filed: Feb. 6, 2007

(51) Int. Cl. B25B 23/08

(52) U.S. Cl. 81/451

(57) ABSTRACT

A screw positioning sleeve assembly comprises an inner sleeve slideably received in an outer sleeve, so that the inner sleeve can be engaged with an ordinary tool rod or a screwdriver to screw or unscrew a screw. When screwing or unscrewing, a magnet in the outer sleeve can attract the screw. During the screwing and unscrewing process, the positioning sleeve can move towards the screw to make the magnet keep attracting the screw, thus preventing the screw from screwing or unscrewing falling off. It is noted that the rod body of the tool rod or the screwdriver can connect with the screw positioning sleeve assembly without any additional preformed structure. Therefore, the scope of applicability of the screw positioning sleeve assembly is enlarged considerably.

### BACKGROUND OF THE INVENTION

1. Field of the Invention

The present invention relates to a screw positioning sleeve assembly, and more particularly to a screw positioning sleeve assembly capable of connecting a conventional tool rod or a screwdriver for screwing or unscrewing a screw.

2. Description of the Prior Art

Referring to FIG. 1, it is an U.S. Pat. No. 7,124,665 (Screw positioning device for a screwdriver). An annular recess 11 is defined at the front end of an outer periphery of a tool rod 10, and the annular recess 11 has certain travel length, so that a positioning sleeve 12 with a magnet 122 disposed in a cutting groove 121 thereof can be directly engaged in the annular recess of the tool rod. By such arrangements, when screwing or unscrewing, the tool rod 10 cooperates with a tool head 13 to screw or unscrew a screw, the magnet 122 can attract the screw. During the screwing and unscrewing process, the positioning sleeve can move towards the screw to make the magnet keep attracting the screw, thus preventing the screw from screwing or unscrewing falling off.

Abovementioned structure is quite simple and practical, and it provides a practical tool with low cost, but after further study, the inventor of the present invention discovered that an annular recess must be preformed in the outer surface of the front end of the tool, then the tool rod can cooperate with the positioning sleeve. Therefore, the tool rod must be particularly manufactured, and the screw positioning device cannot be applied to a conventional tool rod.

Therefore, if an ordinary tool rod without the annular recess can be fitted on the positioning sleeve, the positioning sleeve will be very easy to use and its scope of applicability will be substantially enlarged.

The present invention has arisen to mitigate and/or obviate the afore-described disadvantages.

### SUMMARY OF THE INVENTION

The primary objective of the present invention is to provide a screw positioning sleeve assembly that comprises an inner sleeve slideably received in an outer sleeve, so that the inner sleeve can be engaged with an ordinary tool rod or a screwdriver to screw or unscrew a screw. It is noted that the rod body of the tool rod or the screwdriver can be engaged in the screw positioning sleeve assembly of the present invention without any additional preformed structure. Therefore, the scope of applicability of the screw positioning sleeve assembly is enlarged considerably.

### BRIEF DESCRIPTION OF THE DRAWINGS

FIG. 1 is an exploded view of a screw positioning device for a screwdriver of the U.S. Pat. No. 7,124,665;

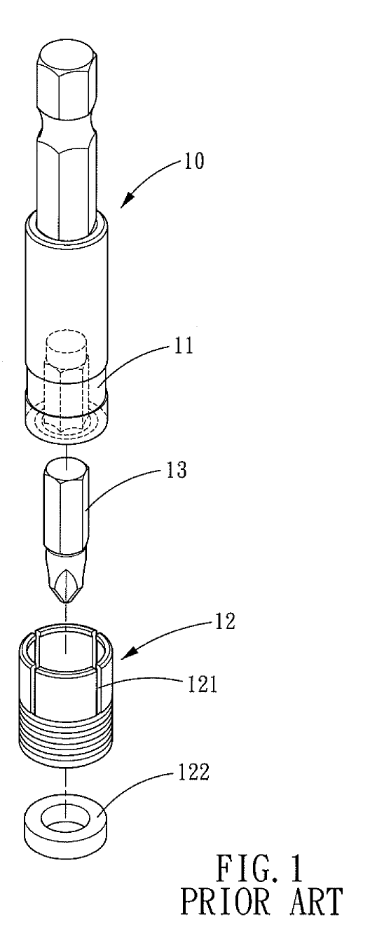

FIG. 2 is an exploded view of a screw positioning sleeve assembly in accordance with the present invention and a tool rod;

FIG. 3 is an assembly view of the screw positioning sleeve assembly in accordance with the present invention and the tool rod;

FIG. 4 is a perspective view of showing that the screw positioning sleeve assembly in accordance with the present invention is connected to the tool rod;

FIG. 5 is a longitudinal sectional view of showing that the screw positioning sleeve assembly in accordance with the present invention is connected to the tool rod;

FIG. 6 is a perspective view of showing that the screw positioning sleeve assembly in accordance with the present invention is screwing or unscrewing a screw;

FIG. 7 is a longitudinal sectional view of showing that the screw positioning sleeve assembly in accordance with the present invention is defined with an O-shaped ring for connecting with the tool rod;

FIG. 8 is a longitudinal sectional view of showing that the screw positioning sleeve assembly in accordance with the present invention is defined with a C-shaped clasp for connecting with the tool rod;

FIG. 9 is a longitudinal sectional view of FIG. 8 of showing that the screw positioning sleeve assembly in accordance with the present invention is connected to the tool rod; and

FIG. 10 is a longitudinal sectional view of showing that the screw positioning sleeve assembly in accordance with the present invention is connected to a screwdriver.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

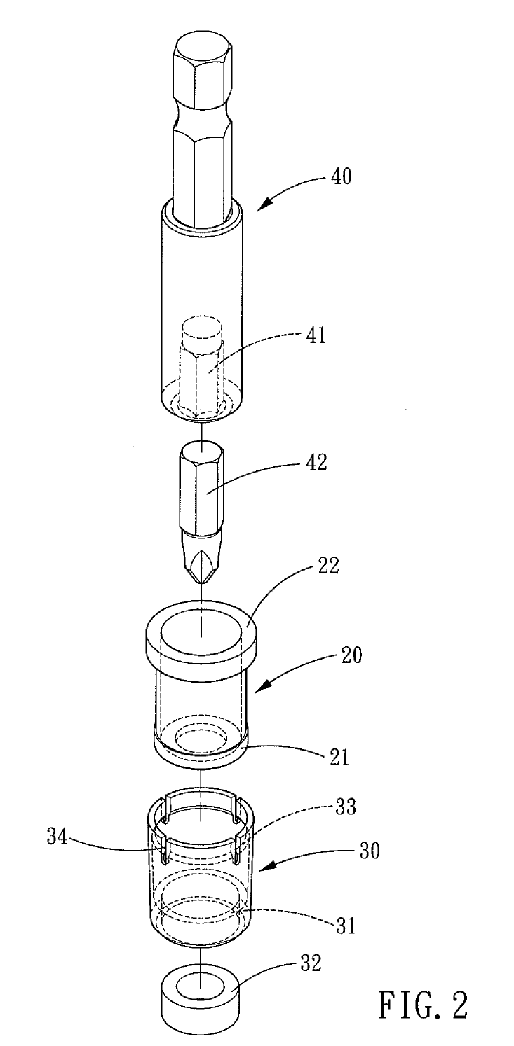

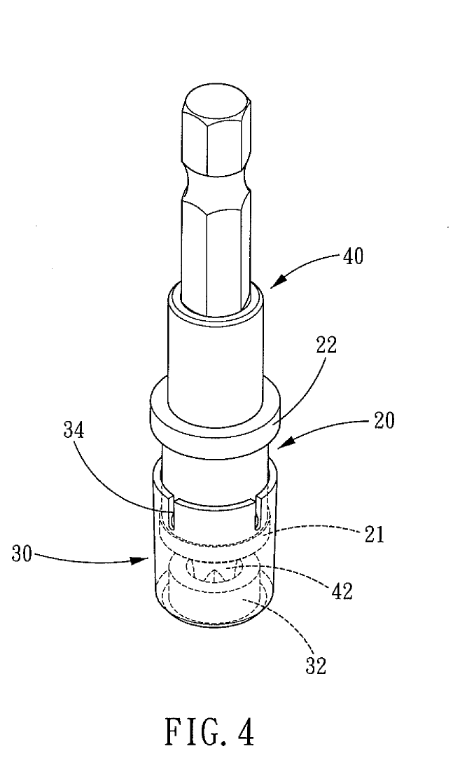

Referring to FIGS. 2-5, the present invention provides a screw positioning sleeve assembly that comprises an inner sleeve 20 slideably received in an outer sleeve 30, so that the inner sleeve can be engaged with an ordinary tool rod to screw or unscrew a screw.

The inner sleeve 20 has a front open end and a rear open end. A front flange 21 is defined on the front end of the outer surface of the inner sleeve 20, and a rear flange 22 is defined on the rear end of the outer surface of the inner sleeve 20.

The outer sleeve 30 has a front open end and a rear open end. A restricting flange 31 is defined on the front end of the inner surface of the outer sleeve 30. A magnet 32 is disposed between the front edge and the restricting flange 31 of the outer sleeve. A stopping flange 33 is defined on the rear end of the inner surface of the outer sleeve 30, and a plurality of open slots 34 is defined in the rear end of the outer sleeve. The rear end of the outer sleeve can expand by force through the open slots 34, so that the outer surface of the inner sleeve 20 can expand to fit on the outer sleeve 30. After that, the slots enable the outer sleeve 30 restore its original shape, and the stopping flange 33 and the front flange 21 mates with each other to prevent the outer sleeve 30 and the inner sleeve 20 from disconnecting from each other. Furthermore, the outer sleeve 30 can move within a fixed travel length along the inner sleeve 20. By such arrangements, the rear open end of the inner sleeve 20 can directly be connected to the tool rod 40 directly to rotate the screw.

Abovementioned is an illustration of the location and the structure of the respectively related subassemblies of the present invention. The structure and the subassemblies of the present invention are simply designed. A user can easily connect the inner sleeve with an ordinary tool rod to screw or unscrew a screw. In addition, the tool rod needs no any additional preformed structure. The following is the description of the operation state of the present invention:

Referring to FIGS. 2-5 again, the outer sleeve 30 of the present invention can be produced by plastic molding, so that the outer sleeve 30 has certain elasticity. By such an arrangement, when assembling the outer sleeve 30 and the inner sleeve 20, the rear end of the outer sleeve 30 can expand through the open slots 34, so that the stopping flange 33 of the outer sleeve 30 favourably passes through the front flange 21 of the inner sleeve 20. After that, the outer sleeve 30 restores its original shape, so that the stopping flange 33 and the front flange 21 are engaged with each other to prevent the outer sleeve 30 and the inner sleeve 20 disconnecting from each other.

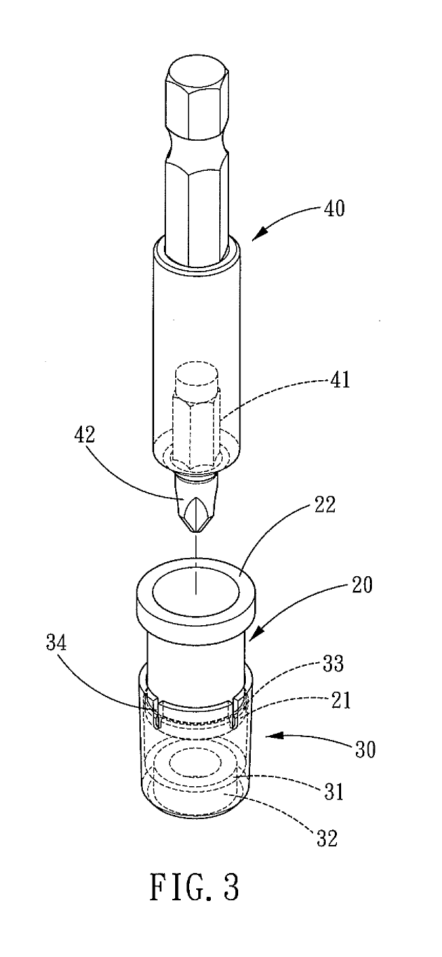

Referring to FIGS. 3-5, an insertion groove 41 is defined in the front end of the ordinary tool rod 40 for insertion of a tool head 42 to screw or unscrew a screw. The front end of the tool rod 40 is commonly cylindrical-shaped, and the rear end of the tool rod 40 can connect with a power driven tool or a hand tool (not shown). When connecting the conventional tool rod 40 to the screw positioning sleeve assembly, the user can directly insert the cylindrical-shaped rod body of the tool rod 40 into the rear open end of the inner sleeve 20 to make the tool rod 40 engage with the inner sleeve 20, so that the tool rod 40 and the screw positioning sleeve assembly are connected together.

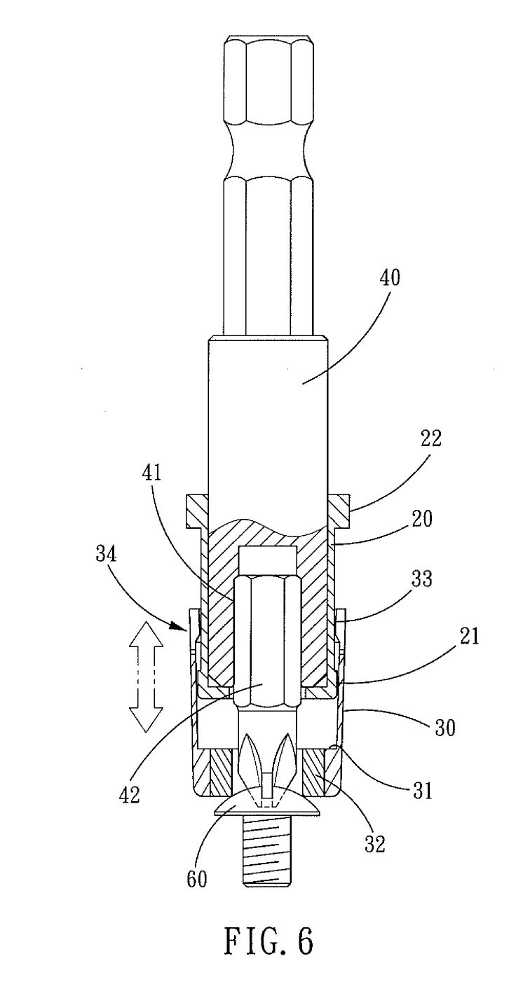

Referring to FIG. 6, when screwing or unscrewing a screw, the magnet 32 in the outer sleeve 30 can attract a screw 60 and drives the outer sleeve 30 to move towards the screw 60, so that, during the course of screwing and unscrewing, the movement of the outer sleeve makes the magnet 32 keep attracting the screw to prevent the screw from screwing or unscrewing falling off.

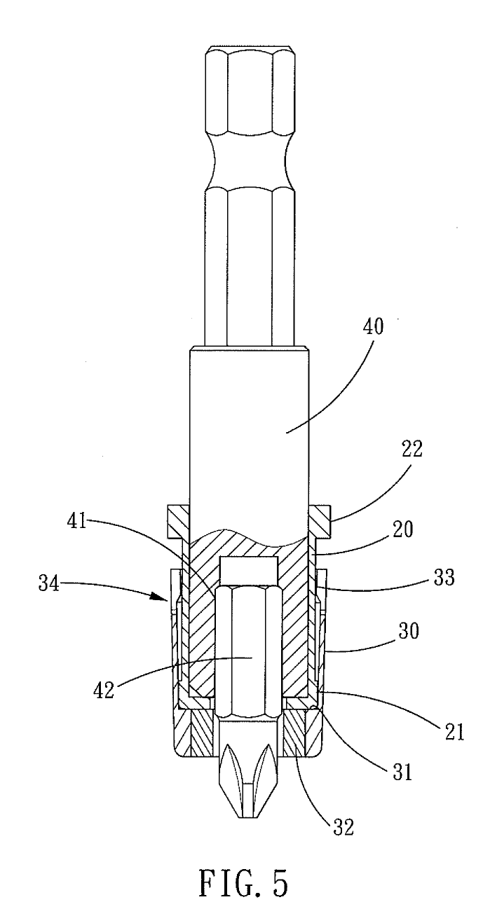

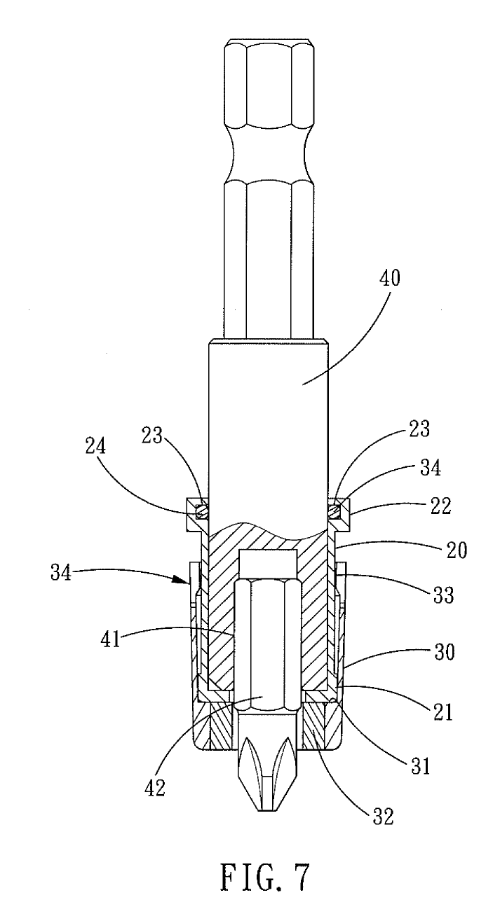

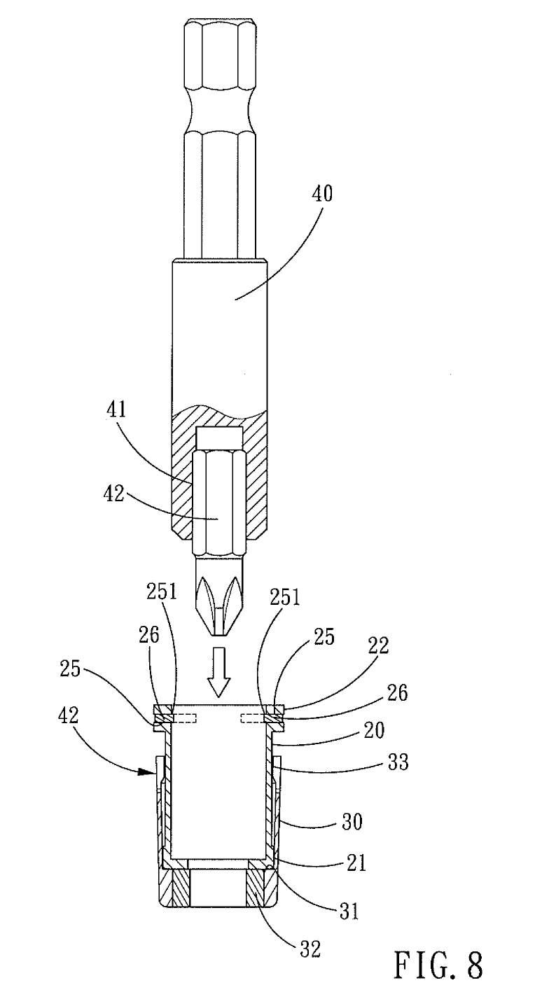

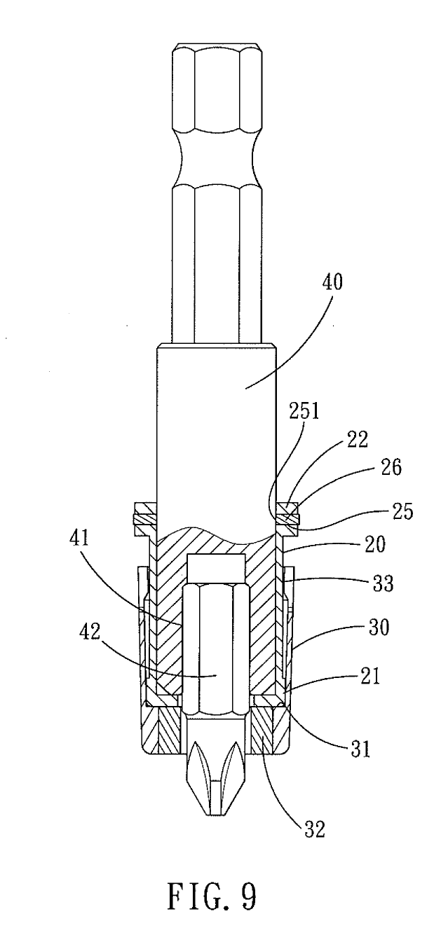

In addition, the tool rod is directly inserted into the rear open end of the inner sleeve. To prevent the tool rod from disconnecting from the inner sleeve, the following several measures can be taken. For example, as shown in FIG. 5, the size of the rear open end of the inner sleeve 20 can be designed to be equal or close to the diameter of the tool rod 40, so that the inner sleeve 20 can be engaged with the tool rod 40. Or as shown in FIG. 7, an annular recess 23 is defined in the rear end of the inner surface of the inner sleeve 20, a rubber O-shaped ring 24 is engaged in the annular recess 23, and a part of the O-shaped ring 24 protrudes out of the annular recess 23 under normal conditions, so that when inserting the tool rod 40 in the inner sleeve 20, the O-shaped ring 24 can tightly clasp an outer surface of the tool rod 40 to position the tool rod. Another measure is shown in FIGS. 8-9, an annular groove 25 is defined in the rear end of the outer surface of the inner sleeve 20, and a plurality of locking holes 251 in communication with the inner space of the inner sleeve 20 is defined in part of the annular groove 25, and a C-shaped clasp 26 is engaged in the annular groove 25 in such a manner that a part of the C-shaped clasp 26 is inserted in the inner sleeve through the locking holes 251, so that when inserting the tool rod 40 in the inner sleeve 20, the C-shaped clasp 26 can tightly clasp the outer surface of the tool rod 40 to position the tool rod.

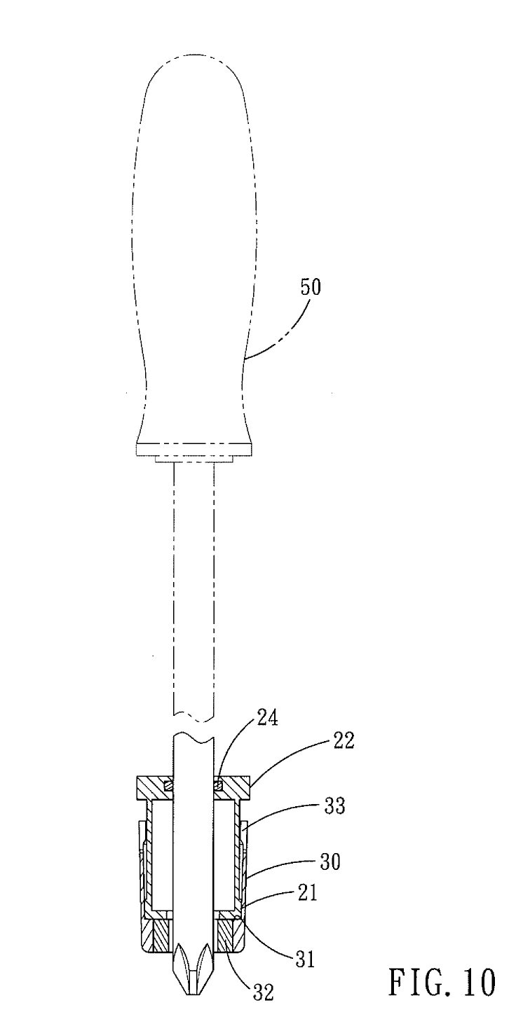

In addition, as shown in FIGS. 10, a conventional screwdriver 50 can fit into the screw positioning sleeve assembly of the present invention. The rod body of the screwdriver 50 is commonly cylindrical-shaped. When connecting with the screw positioning sleeve assembly of the present invention, the user can insert the front end of the rod body of the screwdriver 50 in the rear open end of the inner sleeve 20 and can be positioned therein through the tight clasp of the O-shaped ring, so that the screwdriver 50 can cooperate with the screw positioning sleeve assembly of the present invention to screw or unscrew a screw.

To sum up, the screw positioning sleeve assembly of the present invention can be engaged with an ordinary tool rod or a screwdriver to screw or unscrew a screw. In addition, the rod body of the tool rod or the screwdriver can connect with the screw positioning sleeve assembly of the present invention needs no any additional preformed structure such as an annular recess. Therefore, the scope of applicability of the screw positioning sleeve assembly is enlarged considerably.

While we have shown and described various embodiments in accordance with the present invention, it is clear to those skilled in the art that further embodiments may be made without departing from the scope of the present invention.

1. A screw positioning sleeve assembly for connecting a tool rod to screw or unscrew a screw, comprising:
an inner sleeve having a front open end and a rear open end, a front flange being defined on a front end of an outer surface of the inner sleeve, and a rear flange being defined on a rear end of the outer surface of the inner sleeve; and
an outer sleeve having a front open end and a rear open end, a restricting flange being defined on a front end of an inner surface of the outer sleeve, a magnet being disposed between a front edge and the restricting flange of the outer sleeve, a stopping flange being defined on a rear end of the inner surface of the outer sleeve, and a plurality of open slots being defined in the rear end of the outer sleeve, so that the rear end of the outer sleeve is expandable by force through the open slots, the rear end of the outer sleeve expands to allow the inner sleeve to fit in, after that, the slots enable the outer sleeve restore its original shape, and the stopping flange and the front flange mates with each other to prevent the outer sleeve and the inner sleeve from disconnecting from each other, the outer sleeve can move within a fixed travel length along the inner sleeve, by such arrangements, the rear open end of the inner sleeve directly being connected to the tool rod directly to rotate the screw;
wherein an insertion groove is defined in a front end of the tool rod for insertion of a tool head to screw or unscrew a screw, and a rod body of the tool rod is inserted into the rear open end of the inner sleeve, the tool rod is a screwdriver, a user can insert a front end of the screwdriver in the rear open end of the inner sleeve, so that the screwdriver cooperates with the screw positioning sleeve assembly to screw or unscrew a screw.

2. (canceled)

3. (canceled)

4. The screw positioning sleeve assembly as claimed in claim 1, wherein an annular recess is defined in a rear end of an inner surface of the inner sleeve, a rubber O-shaped ring is engaged in the annular recess, and a part of the O-shaped ring protrudes out of the annular recess, so that after the tool rod is inserted in the inner sleeve, the O-shaped ring will tightly clasp an outer surface of the tool rod to position the tool rod.

5. The screw positioning sleeve assembly as claimed in claim 1, wherein an annular groove is defined in the rear end of the outer surface of the inner sleeve, and a plurality of locking holes in communication with an inner space of the inner sleeve is defined in part of the annular groove, and a C-shaped clasp is engaged in the annular groove in such a manner that a part of the C-shaped clasp is inserted in the inner sleeve through the locking holes, so that after the tool rod is inserted in the inner sleeve, the C-shaped clasp will tightly clasp the outer surface of the tool rod to position the tool rod.
